(19) United States
(12) Patent Application Publication
(10) Pub. No.: US 2024/0286075 A1
(43) Pub. Date: Aug. 29, 2024

(54) POWER-TO-WATER BATTERY AND USES THEREOF

(71) Applicant: CITY UNIVERSITY OF HONG KONG, Kowloon (HK)

(72) Inventors: Wei WU, Kowloon (HK); Haosheng LIN, Kowloon (HK)

(21) Appl. No.: 18/362,922

(22) Filed: Jul. 31, 2023

Related U.S. Application Data
(60) Provisional application No. 63/486,657, filed on Feb. 23, 2023.

(51) Int. Cl. B01D 53/26; B01D 5/00; B01D 71/36

(52) U.S. Cl. CPC B01D 53/263; B01D 5/0075; B01D 71/36; B01D 2252/10; B01D 2252/30; B01D 2257/80; B01D 2259/655; B01D 2311/2626

(57) ABSTRACT

Disclosed herein is a power-to-water (P2W) battery and its use for converting atmospheric water vapor into water by surplus renewable energy. The P2W battery includes, a thermal energy storage (TES) unit made of high-storage-density media for storing heat; a hygroscopic solution container consists of an inner container made of a conduction material for receiving the TES unit therein, a water vapor permeable membrane disposed outside and around the inner container, a hygroscopic solution disposed between a space formed between the inner container and the water vapor permeable membrane; and a condenser disposed downstream and coupled to the hygroscopic solution container; wherein the hygroscopic solution is capable of absorbing the atmospheric water vapor, which is released by heat stored within the TES unit when the TES unit is received in the inner container; and the atmospheric water vapor released from the hygroscopic solution is condensed into water by the condenser.

### CROSS-REFERENCE TO RELATED APPLICATIONS

This application claims priority and the benefit of U.S. Provisional Patent Application No. 63/486,657, filed Feb. 23, 2023, the entirety of which is incorporated herein by reference

### FIELD

### 1. Field of the Invention

The present invention relates to a battery; and more particularly, to a power-to-

water battery for harvesting atmospheric moisture.

### BACKGROUND OF THE INVENTION

### 2. Description of Related Art

Energy storage system (ESS) can bridge the mismatch between renewable energy (e.g., wind power, solar power) supply and end-users' demand, the main concern preventing deeper penetration of renewable energy in the future. The state-of-art ESSs can be classified as mechanical, chemical, electric, electrochemical, thermal, and so forth. However, a scalable, repeatable, and sustainable ESS is still on the way, for existing ESSs still suffer from drawbacks such as specific-terrain requirements, high capacity, low efficiency, environmental problem, and so on.

Meanwhile, there are some overlooked areas for ESSs utilization. For example, with continuous population growth and water pollution, two third of the global population has limited access to safe and clean drinking water. Atmospheric water harvesting (AWH), extracting moisture from the atmospheric air, plays a significant role in alleviating water scarcity. Another field that can benefit from ESSs is humidity control, an important function of heating, ventilation, and air conditioning (HVAC). For example, the potential of using solid or liquid desiccants were reported in recent decades and characterized as environmental-friendly and noise-free options. However, both of them consume a great amount of high-grade energy (typically electricity) for absorbent/desiccant regeneration consumed in regeneration if there is no proper heat source. To address these issues, it is feasible to adopt water-production/dehumidification-armed ESSs powered by excessive renewable energy and thus prevent grid fluctuation and improve AWH/dehumidification economics.

In the present disclosure, we present a novel power-to-water (P2W) battery that can store the electricity as thermal energy in TES and discharge it for water harvesting or humidity control. The environmental-friendly and inexpensive material and the simple production process show significant advantages in practicality and economics over state-of-art ESSs and do not require any specific terrain.

### SUMMARY

Embodiments of the present disclosure relate to a power-to-water (P2W) battery for converting atmospheric water vapor into water by surplus renewable electricity. The P2W battery includes in its structure, at least,
a thermal energy storage (TES) unit made of high-storage-density media for storing heat;
a hygroscopic solution container consists of,
   an inner container made of a conduction material for receiving the TES unit therein;
   a water vapor permeable membrane disposed outside and around the inner container, and
   a hygroscopic solution disposed between a space formed between the inner container and the water vapor permeable membrane for absorbing the atmospheric water vapor; and
a condenser disposed downstream to the hygroscopic solution container and coupled thereto;
wherein,
the hygroscopic solution is capable of absorbing the atmospheric water vapor, which is released by the heat stored within the TES unit when the TES unit is received in the inner container; and
the atmospheric water vapor released from the hygroscopic solution is condensed into the water by the condenser.

Exemplary high-storage-density media suitable for constructing the TES unit may be fire bricks, molten salts, stones, concreates, paraffins, or the like. According to some embodiments of the present disclosure, the TES unit is made of fire bricks. According to alternative embodiments of the present disclosure, the TES unit is made of molten salts selected from the group consisting of potassium nitrate, sodium nitrate, sodium hydroxide, sodium carbonate, lithium chloride, potassium chloride, and a combination thereof. Preferably, the TES unit is made of a combination of molten potassium chloride (about 55% by weight) and molten lithium chloride (about 45% by weight).

According to alternative embodiments of the present disclosure, the TES unit further includes: a heating union that can be electrically charged to produce the heat, and a thermal insulation layer disposed outside and around the TES unit to prevent the heat from dissipating.

Exemplary thermal conductive material suitable for making the inner container includes, but is not limited to, aluminum, copper, gold, iron, silver, stainless steel, carbon, and ceramic. Preferably, the inner container is made of stainless steel.

According to some embodiments of the present disclosure, the hygroscopic solution is the solution of a hygroscopic salt selected from the group consisting of calcium chloride, lithium chloride, lithium bromide, potassium chloride, potassium bromide, potassium hydroxide, zinc chloride, sodium chloride, and sodium hydroxide. According to preferred embodiments of the present disclosure, the hygroscopic salt is calcium chloride.

According to other embodiments of the present disclosure, the hygroscopic solution is an ionic liquid selected from the group consisting of dimethylimidazolium (DMIM)/dimethylpropane (DMP), 1-ethyl-3-methylimidazolium acetate (EMIM)/acetic acid (Ac), 1-butyl-3-methylimidazolium hexafluorophosphate (BMIM)/BF₄, BMIM/Br, DMIM/Cl, and EMIM/EtSO₄. According to preferred embodiments of the present disclosure, the hygroscopic solution is the solution of DMIM/DMP.

According to embodiments of the present disclosure, the water vapor permeable membrane is made of a material selected from the group consisting of polyethylene (PE), polypropylene (PP), polytetrafluoroethylene (PTFE), polyvinylidene fluoride (PVDF) and a combination thereof. According to preferred embodiments of the present disclosure, the water vapor permeable membrane is made of PTFE.

Also disclosed herein are methods for producing water from atmospheric water vapor via use of the present P2W battery. The method comprises steps of,
inserting the TES unit into the inner container of the hygroscopic solution container to release the atmospheric water vapor absorbed by the hygroscopic solution; and
condensing the released atmospheric water vapor into the water by the condenser.

Other and further embodiments of the present disclosure are described in more detail below.

### BRIEF DESCRIPTION OF THE DRAWINGS

The disclosure will become more fully understood from the detailed description and the drawings given herein below for illustration only, and thus does not limit the disclosure, wherein:

FIG. 1A is a schematic diagram depicting the layout and the energy flow of the present P2W battery 100 in accordance with preferred embodiments of the present disclosure;

FIGS. 1B and 1C respectively depict the inner structure of the thermal storage union 110 and the hygroscopic solution container 120 of the P2W battery 100 of FIG. 1A; and

FIG. 1D depicts the operation of the P2W battery 100 of FIG. 1A.

### DETAILED DESCRIPTION

Detailed descriptions and technical contents of the present disclosure are illustrated below in conjunction with the accompanying drawings. However, it is to be understood that the descriptions and the accompanying drawings disclosed herein are merely illustrative and exemplary and not intended to limit the scope of the present disclosure.

Embodiments of the present disclosure include novel power-to-water (P2W) battery and uses thereof for converting atmospheric water vapor into water.

### 1. The power-to-water (P2W) battery

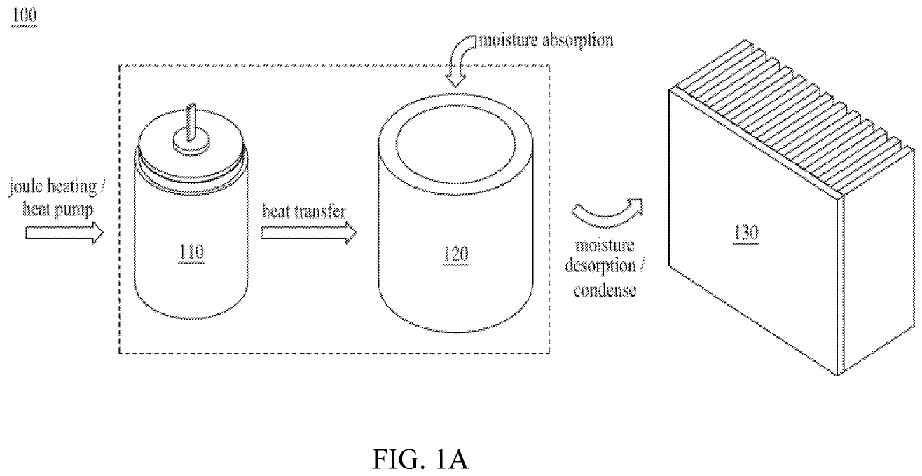

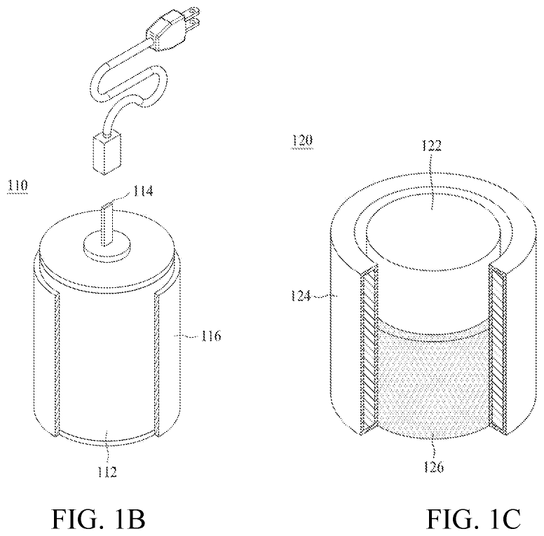

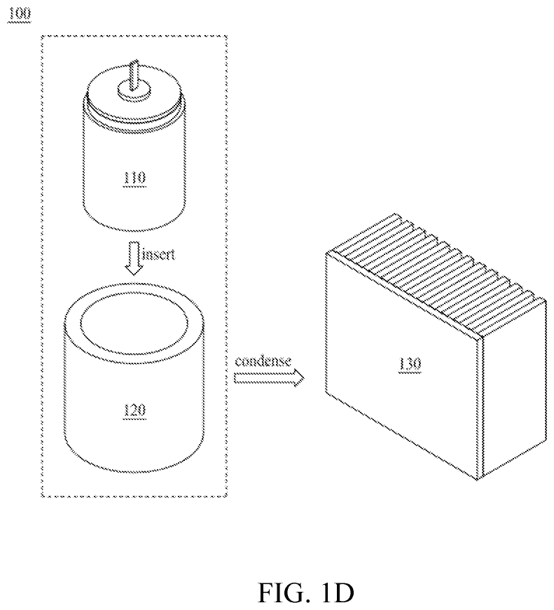

Reference is made to FIG. 1A, which depicts the layout and the energy flow of a P2W battery 100 of the present disclosure. The P2W battery 100 includes, in its structure, a thermal storage (TES) union 110, a hygroscopic solution container 120 and a condenser 130. Note that the TES unit 110 is used to store any surplus energy (e.g., surplus electricity produced by hydro, wind or solar energy) as heat therein, while the hygroscopic solution container 120 is used to absorbed atmospheric moisture. To convert of the absorbed atmospheric moisture into water via the present P2W battery 100, the TES unit 110 is inserted into the hygroscopic solution container 120, so that the heat stored within the TES unit 110 is discharged to release atmospheric moisture that are absorbed within the hygroscopic solution container 120, the released atmospheric moisture is then condensed into water by the condenser 130.

Referring to FIG. 1B, which is a schematic diagram depicting the structure of the TES unit 110 of the P2W battery 100. The TES unit 110 is preferably made of high-storage-density media 112, so that it may store surplus energy (e.g., hydro, wind, or solar energy) in the form of heat. Exemplary high-storage-density media 112 suitable for use in the present disclosure include, but are not limited to, fire bricks, molten salts, stones, concreates, paraffins, and the like. According to some embodiments of the present disclosure, the TES unit 110 is made of fire bricks. According to other embodiments of the present disclosure, the TES unit 110 is made of molten salts selected from the group consisting of potassium nitrate, sodium nitrate, sodium hydroxide, sodium carbonate, lithium chloride, potassium chloride, and a combination thereof. Preferably, the TES unit 110 is made of a combination of molten potassium chloride and molten lithium chloride respectively about 55% and 45% by weight in the combination. Alternatively, or in addition, the TES unit 110 may further include a heating unit 114 that charges the TES unit 110 via electricity (e.g., through a resistive electric heater or heat pump) to produce the heat; and a thermal insulation layer 116 disposed outside and around the TES unit 110 to prevent the heat stored therein from dissipating.

Referring to FIG. 1C, which depicts the structure of the hygroscopic solution container 120 of the P2W battery 100. The hygroscopic solution container 120 includes in its structure, an inner container 122 made of a conduction material and is configured to receive the TES unit 110 therein; a water vapor permeable membrane 124 disposed outside and around the inner container 122, and a hygroscopic solution 126 disposed between a space formed between the inner container 122 and the water vapor permeable membrane 124. The inner container 122 is designed to receive the TES unit 110 therein, thus is hollow inside and preferably made of a material that conducts heat (i.e., a thermal conduction material). Exemplary conduction material suitable for making the inner container 122 includes, but is not limited to, aluminum, copper, gold, iron, silver, stainless steel, carbon, ceramic and the like. Preferably, the inner container 122 is made of stainless steel. Additionally, the outer surface of the inner container 122 is surrounded by a water vapor permeable membrane 124, which is porous in structure thereby allowing water molecules to permeate in and out of the membrane freely. Exemplary material suitable for use as the water vapor permeable membrane 124 includes, but is not limited to, polyethylene (PE), polypropylene (PP), polytetrafluoroethylene (PTFE), polyvinylidene fluoride (PVDF) and a combination thereof. According to preferred embodiments of the present disclosure, the water vapor permeable membrane is made of PTFE. Additionally, the water vapor permeable membrane 124 has a porosity between 0.4 and 0.8, a pore size of about 0.2 to 2.0 μm, and a thickness of about 50 to 200 μm.

According to embodiments of the present disclosure, the inner container 122 is not in direct contact with the water vapor permeable membrane 124, in other words, the inner container 122 is spaced apart from the water vapor permeable membrane 124 by a distance about 20 to 100 mm, thereby leaving a space between them for accommodating the hygroscopic salt solution 126 therein. The term “hygroscopic solution” as used herein refers to a solution of a hygroscopic salt or an ionic liquid that absorbs water vapor from the air or its surroundings. Exemplary hygroscopic salt suitable for forming the hygroscopic solution 126 includes, but is not limited to, calcium chloride, lithium chloride, lithium bromide, potassium chloride, potassium bromide, potassium hydroxide, sodium chloride, zinc chloride, and sodium hydroxide. Exemplary ionic liquid suitable for use as the hygroscopic solution 126 includes, but is not limited to, dimethylimidazolium (DMIM)/dimethylpropane (DMP), 1-ethyl-3-methylimidazolium acetate (EMIM)/acetic acid (Ac), 1-butyl-3-methylimidazolium hexafluorophosphate (BMIM)/BF₄, BMIM/Br, DMIM/Cl, and EMIM/EtSO₄. According to some embodiments of the present disclosure, the hygroscopic solution is the solution of calcium chloride. According to other embodiments of the present disclosure, the hygroscopic solution is DMIM/DMP solution.

A condenser 130 is disposed downstream to the hygroscopic solution container 120 for condensing water vapor released from the hygroscopic solution 126. According to embodiments of the present disclosure, the condenser 130 may be a heat sink.

### 2. Uses of the P2W battery

Reference is made to Fig. 1D, which depicts the operation of the P2W battery 100 to convert atmospheric water vapor into water. Prior to commencing the present method, the TES unit 110 of the P2W battery 100 is charged (i.e., by joule heating or heat pump) and the energy is stored in the form of heat inside the TES unit 110 in a thermal insulation environment; at the same time, the hygroscopic salt solution container 120 is let stand in a humid environment for a sufficient period of time to absorb water vapor from its surroundings (e.g., from air), in which the atmospheric water vapor permeates through the porous water vapor permeable membrane 124 of the P2W battery 100 and is absorbed by the hygroscopic solution 126 disposed between the water vapor permeable membrane 124 and the inner container 122. During operation of the P2W battery 100, the fully charged TES unit 110 is inserted into the hygroscopic solution container 120, specifically, into the hollow inner container 122 made of a material that conducts heat, so that the heat stored within the TES unit 110 is transferred from the TES unit 110 to the hygroscopic salt solution 126 disposed around and outside the inner container 122. Accordingly, the temperature of the hygroscopic solution 126 will rise due to the transferred heat, which in turn cause the release of the absorbed water vapor from the hygroscopic salt solution 126. The released water vapor again may permeate freely out of the porous water vapor permeable membrane 124 and is subsequently condensed into water by the condenser 130 (e.g., a heat sink). The freshly produced water may then be collected and put into use.

According to embodiments of the present disclosure, once the water vapor absorbed by the hygroscopic solution 126 is completely released or the TES unit 110 is fully discharged, the P2W battery 100 may be regenerated via retracting the TES unit 110 out of the inner container 122 of the hygroscopic solution container 120, and recharge the TES unit 110 directly via electricity or any surplus energy; while the hygroscopic solution container 120 may be returned to the more humid environment (e.g., relative humidity (RH)>60%). As the atmospheric air is cooler and more humid at nighttime, thus, the hygroscopic solution 126 in the hygroscopic solution container 120 would be more efficient to absorb atmospheric water at night, which in turn, ensures a higher battery efficiency. Incidentally, the electricity price is typically low under a time-of-use tariff policy, which highly matches the P2W battery requirement: low-cost charging and high-peak saving ability.

The present invention will now be described more specifically with reference to the following embodiments, which are provided for the purpose of demonstration rather than limitation. While they are typically of those that might be used, other procedures, methodologies, or techniques known to those skilled in the art may alternatively be used.

### EXAMPLES

### EXAMPLE 1 Production and Characterization of the Present Power-To-Water (P2W) Battery

### 1.1 Fabrication a Prototype of the Present P2W Battery

A prototype of a P2W battery was constructed in accordance with the layout depicted in FIG. 1A, in which the TES unit was emulated by an electric heater that was about 2 cm in diameter and 6.5 cm in height, a sealed water collection chamber serving as the condenser was coupled to the P2W battery to collect freshwater generated therefrom.

A preliminary test run of the prototype resulted in about 1.7 ml water being collected in the chamber with a heating power of 722 W/m², which corresponded to a freshwater production rate of 41 g/(L_{device}·h) or 0.22 g/(g_{LiBr}·h) that significantly outperformed the state-of-art active AWH technologies.

### 1.2 Techno-Economics of the P2W Battery

Round-trip efficiency (RTE), capital per energy (CPE), and cost per power (CPP) are the three main characteristics of merit that reflect the capability of any storage technology. To investigate the performance of the present P2W battery in terms of RTE, CPE and CPP, 6 P2W batteries were constructed in similar manner as that of Example 1.1, except fire brick (FB) or molten salts (MS) were independently used as the thermal storage medium.

It was found that the RTE of the P2W battery (in which FB served as the TES) reached a level as high as 90% in large-scale storage.

Generally, high efficiency and low CPP are important for short-duration storage applications, whereas low CPE is important for long-duration storage applications. It was found that P2W battery possessed a significant advantage over other Power-to-Power options, especially in CPE, which means that P2W is attractive in long-duration storage applications. A wide range of CPP values, starting at ˜20 $/KW (CaCl₂) to 800 $/kW (LiBr), is possible for P2W depending on the choice of hygroscopic solutions, the atmospheric vapor pressure, or the container dimensions. Further, it is worth noting that the employing CaCl₂ as the hygroscopic salt in a P2W battery enables a significant advantage in CPP.

It will be understood that the above description of embodiments is given by way of example only and that various modifications may be made by those with ordinary skill in the art. The above specification, examples and data provide a complete description of the structure and use of exemplary embodiments of the invention. Although various embodiments of the invention have been described above with a certain degree of particularity, or with reference to one or more individual embodiments, those with ordinary skill in the art could make numerous alterations to the disclosed embodiments without departing from the spirit or scope of the present disclosure.

What is claimed is:

1. A power-to-water battery for converting atmospheric water vapor into water comprising:
a thermal energy storage (TES) unit made of high-storage-density media for storing heat;
a hygroscopic solution container consists of, an inner container made of a conduction material for receiving the TES unit therein;
a water vapor permeable membrane disposed outside and around the inner container, and
a hygroscopic solution disposed between a space formed between the inner container and the water vapor permeable membrane; and
a condenser disposed downstream and coupled to the hygroscopic solution container; wherein,
the hygroscopic solution is capable of absorbing the atmospheric water vapor, which is released by the heat stored within the TES unit when the TES unit is received in the inner container; and
the atmospheric water vapor released from the hygroscopic solution is condensed into the water by the condenser.

2. The power-to-water battery of claim 1, wherein the high-storage-density media are fire bricks, molten salts, stones, concreates, or paraffins.

3. The power-to-water battery of claim 2, wherein the molten salts are selected from the group consisting of potassium nitrate, sodium nitrate, sodium hydroxide, sodium carbonate, lithium chloride, potassium chloride and a combination thereof.

4. The power-to-water battery of claim 3, wherein the molten salts are a combination of molten potassium chloride and molten lithium chloride respectively about 55% and 45% by weight in the combination.

5. The power-to-water battery of claim 2, wherein the TES unit is made of fire bricks.

6. The power-to-water battery of claim 2, wherein the TES unit further comprises:
a heating unit capable of being charged by electricity to produce the heat; and
a thermal insulation layer disposed outside and around the TES unit to prevent the heat from dissipating.

7. The power-to-water battery of claim 1, wherein the conduction material is selected from the group consisting of aluminum, copper, gold, iron, silver, stainless steel, carbon and ceramic.

8. The power-to-water battery of claim 1, wherein the hygroscopic solution is the solution of a hygroscopic salt selected from the group consisting of calcium chloride, lithium chloride, lithium bromide, potassium chloride, potassium bromide, potassium hydroxide, sodium chloride, zinc chloride, and sodium hydroxide.

9. The power-to-water battery of claim 8, wherein the hygroscopic salt is calcium chloride.

10. The power-to-water battery of claim 1, wherein the hygroscopic solution is the solution of an ionic liquid selected from the group consisting of dimethylimidazolium (DMIM)/dimethylpropane (DMP), 1-ethyl-3-methylimidazolium acetate (EMIM)/acetic acid (Ac), 1-butyl-3-methylimidazolium hexafluorophosphate (BMIM)/BF₄, BMIM/Br, DMIM/Cl, and EMIM/EtSO₄.

11. The power-to-water battery of claim 1, wherein the water vapor permeable membrane is made of a material selected from the group consisting of polyethylene (PE), polypropylene (PP), polytetrafluoroethylene (PTFE), polyvinylidene fluoride (PVDF) and a combination thereof.

12. The power-to-water battery of claim 11, wherein the water vapor permeable membrane is made of PTFE.

13. A method for converting atmospheric water vapor into water via use of the power-to-water battery of claim 1 comprising:
inserting the TES unit into the inner container of the hygroscopic solution container to release the atmospheric water vapor absorbed by the hygroscopic salt solution; and
condensing the released atmospheric water vapor into the water by the condenser.

14. The method of claim 13, wherein the high-storage-density media are fire bricks, molten salts, stones, concreates, or paraffins.

15. The method of claim 14, wherein the molten salts are selected from the group consisting of potassium nitrate, sodium nitrate, sodium hydroxide, sodium carbonate, lithium chloride, potassium chloride and a combination thereof.

16. The method of claim 15, wherein the molten salts are a combination of molten potassium chloride and molten lithium chloride respectively about 55% and 45% by weight in the combination.

17. The method of claim 14, wherein the TES unit is made of fire bricks.

18. The method of claim 14, wherein the TES unit further comprises:
a heating unit capable of being charged by electricity to produce the heat; and
a thermal insulation layer disposed outside and around the TES unit to prevent the heat from dissipating.

19. The method of claim 13, wherein the conduction material is selected from the group consisting of aluminum, copper, gold, iron, silver, stainless steel, carbon and ceramic.

20. The method of claim 13, wherein the hygroscopic solution is the solution of a hygroscopic salt selected from the group consisting of calcium chloride, lithium chloride, lithium bromide, potassium chloride, potassium bromide, potassium hydroxide, sodium chloride, zinc chloride, and sodium hydroxide.

21. The method of claim 20, wherein the hygroscopic salt is calcium chloride.

22. The method of claim 13, wherein the hygroscopic solution is an ionic liquid selected from the group consisting of dimethylimidazolium (DMIM)/dimethylpropane (DMP), 1-ethyl-3-methylimidazolium acetate (EMIM)/acetic acid (Ac), 1-butyl-3-methylimidazolium hexafluorophosphate (BMIM)/BF₄, BMIM/Br, DMIM/Cl, and EMIM/EtSO₄.

23. The method of claim 13, wherein the water vapor permeable membrane is made of a material selected from the group consisting of polyethylene (PE), polypropylene (PP), polytetrafluoroethylene (PTFE), polyvinylidene fluoride (PVDF) and a combination thereof.

24. The method of claim 23, wherein the water vapor permeable membrane is made of PTFE.
